(19) United States
(12) Patent Application Publication
(10) Pub. No.: US 2005/0213144 A1
(43) Pub. Date: Sep. 29, 2005

(54) Print management

(75) Inventor: Hiroyoshi Uejo, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/967,169

(22) Filed: Oct. 19, 2004

(30) Foreign Application Priority Data
Mar. 23, 2004 (JP) 2004-84596

(51) Int. Cl. G06F 15/00

(52) U.S. Cl. 358/1.15; 358/1.13

(57) ABSTRACT

A print managing apparatus is included in a printing system has an input section, detecting section and an output section. The input section inputs the printing instruction which describes each printing step of printing linkage steps which offers a printing related service. The detecting section detects a processing section, which interprets the printing instruction described in a predetermined description format and processes the printing related service, which are provided for the respective printing steps described in the printing instruction and detects a description format which can be interpreted at the processing section. The output section sets the processing section for processing the printing step which offers the printing related service and outputs a work instruction in which work items relating to the printing step are described in a description format which can be interpreted at the set processing section.

### CROSS-REFERENCE TO RELATED APPLICATION

This application claims priority under 35 USC 119 from Japanese Patent Application 2004-84596, the disclosure of which is incorporated by reference herein.

### BACKGROUND OF THE INVENTION

1. Technical Field

The present invention relates to print management including a print managing apparatus, method, program, and recording medium, and to a printing system. For example, the present invention relates to a print managing apparatus, method, program, and recording medium, and to a printing system which manage the print processing of printed matter when carrying out printing via a plurality of printing steps using a printing plate, or when carrying out printing via a plurality of printing steps using an image forming apparatus (such as a printer or the like) which has a so-called printing function which forms an image onto a recording medium.

2. Description of the Related Art

In conventional printing (e.g., offset printing), for example, the intermediate products of a print of a photocomposition (photographic printing paper), a block copy, a negative halftone, a positive halftone, and a presensitized printing (PS) plate are prepared, and printing and binding are carried out by using these intermediate products as the bases for the printing and binding.

For example, the printing step includes the facing step, the RIP step, the CTP step, the printing press step, the folding machine step, the cutting machine step, and the binding machine step. The facing step is a step of deciding upon the image positions in accordance with the layout. The RIP step is a step of preparing image data for printing from the layout data. The CTP step is a step of preparing a printing plate from the image data. The printing press step is a step of carrying out printing by using the printing plate. The folding machine step is a step of carrying out folding in accordance with the specifications of the printed media. The cutting machine step is a step of cutting, in accordance with specifications, the media which have undergone folding after printing. The binding machine step is a step of binding, in accordance with specifications, the media which have undergone folding and cutting after printing. These respective printing steps are carried out independent of one another, and are an independent processing for each step.

In recent years, owing to the increased popularity of DTP (Desktop Publishing/Prepress), “direct printing” or “on demand printing, which is printing directly from the DTP data, has come to be known. In DTP, the following processings are coming into wide use: printing data, which is obtained by processing the page layout on a computer, is formed on a photographic printing paper or a plate-making film, and on the basis thereof, a printing plate is prepared and printing is carried out. Further, much attention is also being paid to CTP (Computer-To-Plate) in which a printing plate is formed directly from electronic data without forming an intermediate product. Image forming apparatuses which are equipped with a printing function, such as printers and copy machines, are known as structures which can be used in such print processing.

DTP is possible by common usage of electronic data in some of the steps of printing peripheral to the image forming apparatus, and cannot be used in all of the processes of print processing. Further, it is difficult to use in conventional printing processes.

CIP4 proposed by the Heidelberg group (Heidelberg USA, Inc.) headquatered in Heidelberg, Germany, is a control method which automates the printing work flow. Not only venders of printing presses, but handling of Prepress and Postpress as well is being carried out in accordance therewith. In this way, instructions from abstract instructions to detailed instructions reaching to the device or the image processing or operation are given, such that the printing step, which conventionally had been carried out manually, is semi-automated.

In electrophotographic printers which are often used in offices, automation by giving instructions from a client to respective devices has been proposed. In recent years, attempts have been made to use, as printed matter, output (prints) formed by electrophotographic processing, as is seen in digital color structures by printers and on-demand printing. However, only some of the processes have been automated. This is because there is the need to individually ready the apparatuses which are used exclusively for the respective printing steps, and it is difficult to manage and exercise general control over the entire system.

### SUMMARY OF THE INVENTION

The present invention has been developed in view of the aforementioned. A print managing apparatus, method, program, storage medium, and a printing system are demanded which, when executing plural printing steps in order to obtain a printed matter, are not limited to the description format of the printing instruction.

The present invention is applied to cases of managing the print processing of a printed matter, in a printing system which carries out print processing of an image onto a recording medium in accordance with a printing instruction in which request items, which express the requirements for the preparation of the printed matter, are described in a predetermined description format.

The printing instruction is electronic data. In the contents of this data, printing linked steps, a plurality of which implement printing steps offering printing related services which are classified in advance from a request to the furnishing of the printed matter, are described for each of the printing steps. A processing section is provided at each printing step. The processing section interprets at least one of a printing instruction in a predetermined description format and a printing instruction in a description format which is different from the predetermined description format. From the interpreted results, the processing section processes the printing related service in its own printing step. The management side detects the processing sections provided for the respective printing steps of the printing system. In this way, the management side can learn of the processing sections of the respective printing steps. Further, the management side detects the description formats which can interpret the printing instructions at the processing sections. It can thereby be judged whether or not interpretation of a printing instruction is possible.

When print processing is carried out in accordance with a printing instruction for obtaining a printed matter, a processing section is set for each of the printing steps included in that printing instruction. A work instruction, in which work items relating to the printing step are described in a description format which can be interpreted at the set processing section, is prepared and outputted as the printing instruction. In this way, the processing sections included in the printing system can be provided without being limited to the description format of a printing instruction. Accordingly, when executing a plurality of printing steps in order to obtain a printed matter, a printing system can be structured regardless of the interfaces particular to the processing sections, such as the languages particular to the apparatuses, and the printing system can be configured without being limited to the description format of the printing instruction. The processing sections can thereby be structured by using a variety of apparatuses, and the printing system can easily be automated.

As described above, in accordance with the present invention, the description format which can interpret a printing instruction at the processing section of a printing step can be detected, and a printing instruction in a corresponding description format can be outputted. Therefore, even if there is a printing instruction in accordance with different formats, the processings at the processing steps within the printing system are possible, and it is easy to develop the printing system to have better abilities and more functions.

### BRIEF DESCRIPTION OF THE DRAWINGS

Embodiments of the present invention will be described hereinafter in detail with reference to the following drawings.

FIG. 1 is a block diagram showing the structure of a print processing system relating to an embodiment of the present invention.

FIG. 2 is a block diagram showing the basic structure of respective apparatuses structuring the print processing system relating to the embodiment of the present invention.

FIG. 3 is a block diagram for explaining the interrelationships among the respective apparatuses structuring the print processing system.

FIGS. 4A through 4D are image diagrams showing the structure of a printing instruction and the flow of data addition, where FIG. 4A shows only basic fields, FIG. 4B shows fields including the request specifications of a user, FIG. 4C shows fields including specifications for each printing related step, and FIG. 4D shows fields including detailed specifications for each printing related step.

FIG. 5 is a process flowchart relating to linked processings from a request for a printed matter to obtaining of the printed matter.

FIG. 6 is a process flowchart relating to a processing which is carried out at a processing apparatus which is in charge of one printing related step.

FIG. 7 is a diagram showing the flow of the printing steps.

FIG. 8 is a process flowchart executed in a printing instruction which includes a printing step for color proofing.

FIG. 9 is a flowchart showing the flow of processing at an MIS apparatus.

### DETAILED DESCRIPTION OF THE INVENTION

First, before an embodiment of the present invention is described, aspects of the present invention will be described. Aspects which include embodiments of various technical items will also be described.

A first aspect is a print managing apparatus included in a printing system which carries out print processing of an image onto a recording medium in accordance with a printing instruction in which request items expressing requirements for preparation of a printed matter are described in a predetermined description format, the print managing apparatus managing print processing of the printed matter, the apparatus comprising: an input section that inputs the printing instruction which describes each printing step of printing linkage steps which offers a printing related service; a detecting section that detects a processing section, which interprets the printing instruction described in a predetermined description format and processes the printing related service, which are provided for the respective printing steps described in the printing instruction and detects a description format which can be interpreted at the processing section; and an output section that sets the processing section for processing the printing step which offers the printing related service and outputs a work instruction in which work items relating to the printing step are described in a description format which can be interpreted at the set processing section.

In the present aspect, the input section inputs, as the printing instruction, a printing instruction in which printing linked steps, a plurality of which implement printing steps, are described for each of the printing steps. The printing system has, for the printing steps, processing sections which process their own printing linked services. The printing instruction for the processing is structured so as to include a mixed environment of the predetermined description format and any description format which is different from the predetermined description format. Thus, the detecting section detects the processing sections of the respective printing steps and included in the printing system, and detects the description formats which can be interpreted at the processing sections. When the printing linked steps are to be carried out, the output section sets a processing section for each of the printing steps included in the inputted printing instruction. The setting of the processing sections can be carried out by using the results of detection of the detecting section, or the processing sections can be set in advance. When the results of detection are used, the processing sections may be displayed for each of the printing steps by a display means, and the operator may set the processing sections by designating and inputting them, or the detected processing sections which are physically the closest may be automatically selected. On the other hand, when the settings of the processing sections are set in advance, the processing section for each printing step in the printing system is known in advance, and this information is stored in a memory such as a table or the like. A processing section is set for each printing step by referring to the table in the memory. Then, the output section prepares and outputs a work instruction in which work items relating to a printing step are described in a description format which can be interpreted at the set processing section. The description format which can be interpreted at that processing section can be determined by using the results of detection of the detecting section, or can be set in advance. When the results of detection show that plural description formats are possible, a description format can be set, as described above, by being set by designation and input by the operator, or a pre-set description format may be automatically selected. On the other hand, if the description format is predetermined, the description formats of the processing sections, which description formats are known of in advance, are set in advance and stored in a memory such as a table or the like, and the description format is set by referring thereto.

In this way, the output section outputs instructions to the processing sections included in the printing system, in printing instruction description formats which can be interpreted at the processing sections. It is thereby possible to prevent the structure of the printing system from being limited due to the description formats which can be interpreted at the processing sections being limited in advance. Namely, a processing section can be added to the printing system without being limited by the description format.

A second aspect is that the printing system includes a plurality of the processing sections, and the plurality of the processing sections includes at least one of a processing section which interprets printing instructions in the predetermined description format and processing its own printing related service, and a processing section which interprets printing instructions in another description format different from the predetermined description format and processing its own printing related service.

A third aspect has the feature that, in the print managing apparatus of the first aspect, the detecting section detects an operation state of the processing section in charge of the printing step, and, when that processing section is detected to be non-operable, the output section sets a predetermined processing section which can be in charge of that printing step.

In the present aspect, the detecting section detects the operation state of the processing section. The operation state may be the connection state, which expresses whether or not the processing section is connected to the print managing apparatus via a network or the like, or may be the processing state, which expresses whether or not processing is possible at the processing section. The state values of the operation state are operable, which expresses that operation is possible, and non-operable, which expresses that operation is difficult due to non-connection, a malfunction, the processing section currently carrying out another processing, or the like. When a processing section is detected to be non-operable, the output section sets a processing section which can be in charge of that printing step. A processing section which can be in charge of that printing step is set in advance as another processing section which can execute that printing step. For example, when a substitute apparatus is set, that apparatus becomes the processing section. In this way, if a processing section in an arbitrary printing step cannot operate, the printing step can be accomplished by another processing section instead of that processing section.

A fourth aspect has the feature that, in the print managing apparatus of the second aspect, the detecting section detects the operation state of the processing section when print processing of the image onto the recording medium in accordance with the printing instruction is to be carried out.

In the present aspect, when print processing is to be carried out, the operation state of the processing section is detected. In this way, the operation states of the processing sections within the printing system can be learned of in real time when print processing is actually carried out, i.e., at the time of processing. Thus, advance detection processing is unnecessary, and it is possible to avoid problems in operation caused by there being differences between the operation states at the time of detection and the operation states at the time of processing in a case in which advance detection is carried out.

A fifth aspect has the feature that, in the print managing apparatus of any of the first through third aspects, the printing steps include at least a proofing processing step.

In the present aspect, the printing steps include at least a proofing processing step. The printing linked processings have various types of printing forms. By including a proofing processing step among the printing steps, a request of a user can be handled quickly.

A sixth aspect has the feature that, in the print managing apparatus of the any of the first through fourth aspects, the processing section is structured from an agent portion which interprets the work instruction and converts the interpreted work instruction into data particular to an apparatus and outputs the data particular to the apparatus, and an executing portion which processes the printing related service on the basis of the data particular to the apparatus.

In the present aspect, the processing section is structured from an agent portion and an executing portion. The agent portion interprets the work instruction, and converts the interpreted work instruction into data particular to an apparatus, and outputs the data particular to the apparatus. The agent portion has, for the executing portion subordinate thereto, a converting means for converting between data particular to the apparatus and data of the printing instruction. The executing portion processes the printing related service on the basis of the data particular to the apparatus from the agent portion. In this way, by providing the agent portion, the executing portion, which processes the printing related service, does not need a structure for interpreting the printing instruction. It is thereby possible to add, to the printing system, an executing portion provided at a processing section, without being limited to the description format.

A seventh aspect has the feature that, in the print managing apparatus of the fifth aspect, the agent portion converts the work instruction into data particular to the apparatus, which data corresponds to the work instruction and is in accordance with predetermined parameters particular to the executing portion.

Among apparatuses which process printing steps, there are many apparatuses which operate by data in accordance with preset parameters. Thus, in the present aspect, the agent portion converts into data which is particular to the apparatus, which data corresponds to the work instruction and is in accordance with pre-set parameters which are particular to the executing portion. In this way, at the processing section, an examination instruction can be flexibly outputted to the executing portion.

A eighth aspect has the feature that, in the print managing apparatus of any of the first through sixth aspects, the printing instruction in the description format different from the predetermined description format, or the work instruction which describes work items and which can be interpreted at the processing section, describes details of processings to be implemented in the printing step.

The printing step has detailed data, which is used only at the time of processing in that printing step, and detailed data, which is used only within the processing section. There are cases in which this data has no meaning in other printing steps. On the other hand, there are processing sections which process only specific items described in the printing instruction. Thus, the present aspect is applied to cases in which the work instruction or the printing instruction of a description format different from the predetermined description format, describes details of the processing to be executed in the processing step. In this way, although the printing instruction or the like in the predetermined description format does not include detailed items, items in line with the request for obtaining the printed matter are described therein, and the printing linked processing can be carried out on the basis thereof. On the other hand, the printing instruction or the like in the description format different from the predetermined description format does include detailed items, and the printing linked processing can be carried out in accordance with these detailed items.

An ninth aspect of the present invention is a printing managing method executable in a printing system which carries out print processing of an image onto a recording medium in accordance with a printing instruction in which request items expressing requirements for preparation of a printed matter are described in a predetermined description format, the printing managing method managing print processing of the printed matter. The method comprises inputting a printing instruction which describes each printing step of printing linkage steps which offers a printing related service; detecting a processing section, which interprets the printing instruction described in a predetermined description format and processes the printing related service; detecting a description format which is interpretable at the processing section; and for each of the printing steps included in the inputted printing instruction, setting the processing section for processing the printing step which offers the printing related service and outputs a work instruction in which work items relating to the printing step are described in a description format which is interpretable at the set processing section.

In a printing system, there is the need to manage the print processing of a printed matter. Thus, when managing the print processing of printed matter in a printing system which carries out print processing of an image onto a recording medium in accordance with a printing instruction in which request items expressing requirements for preparation of a printed matter are described in a predetermined description format, the present aspect includes steps of: inputting, as the printing instruction, a printing instruction in which printing linked steps, a plurality of which implement printing steps offering printing related services which are classified in advance from a request to furnishing of the printed matter, are described for each of the printing steps; when at least one of a processing section interpreting printing instructions in the predetermined description format and processing its own printing related service, and a processing section interpreting printing instructions in another description format different from the predetermined description format and processing its own printing related service, are provided for each of the printing steps, detecting the processing sections which are provided for the respective printing steps and which are included in the printing system, and detecting description formats which can be interpreted at those processing sections; and for each of the printing steps included in the inputted printing instruction, setting a processing section for processing the printing related service in charge of that printing step, and preparing and outputting a work instruction in which work items relating to that printing step are described in a description format which can be interpreted at the set processing section. In this way, in the printing system, the print processing of the printed matter can be easily executed even if there are both printing instructions in the predetermined description format and printing instructions in a description format different from the predetermined description format, and the processing sections can each interpret only one of these description formats.

A tenth aspect of the present invention is a printing managing program executable by a computer provided at a printing system which carries out print processing of an image onto a recording medium in accordance with a printing instruction in which request items expressing requirements for preparation of a printed matter are described in a predetermined description format, the printing managing program which manages print processing of the printed matter. The program comprises causing input of a printing instruction which describes each printing step of printing linkages steps which offers a printing related service; causing detection of a processing section which interprets the printing instruction described in a predetermined description format and processes the printing related service; causing detection of a description format which is to be interpreted; for each of the printing steps included in the inputted printing instruction, causing setting of a processing section for processing the printing step which offers the printing related service; and causing outputting a work instruction in which work items relating to the printing step are described in a description format which is interpretable at the set processing section.

In order to manage the print processing of a printing matter in the above-described print managing apparatus, a managing program therefor is needed. Thus, the present aspect is a printing managing program executable at a server provided at a printing system which carries out print processing of an image onto a recording medium in accordance with a printing instruction in which request items expressing requirements for preparation of a printed matter are described in a predetermined description format, and the printing managing program manages the print processing of the printed matter. The printing managing program includes the steps of: causing input, as the printing instruction, of a printing instruction in which printing linked steps, a plurality of which implement printing steps offering printing related services which are classified in advance from a request to furnishing of the printed matter, are described for each of the printing steps; when at least one of a processing section interpreting printing instructions in the predetermined description format and processing its own printing related service, and a processing section interpreting printing instructions in another description format different from the predetermined description format and processing its own printing related service, are provided for each of the printing steps, causing detection of the processing sections which are provided for the respective printing steps and which are included in the printing system, and detection of description formats which can be interpreted at those processing sections; and for each of the printing steps included in the inputted printing instruction, causing setting of a processing section for processing the printing related service in charge of that printing step, and causing preparation and output of a work instruction in which work items relating to that printing step are described in a description format which can be interpreted at the set processing section. In accordance with this printing managing program, at the print managing apparatus, the print processing of the printed matter can be easily executed even if there are both printing instructions in the predetermined description format and printing instructions in a description format different from the predetermined description format, and the processing sections can each interpret only one of these description formats.

A eleventh aspect of the present invention is a storage medium storing a printing managing program executable by an apparatus provided at a printing system which carries out print processing of an image onto a recording medium in accordance with a printing instruction in which request items expressing requirements for preparation of a printed matter are described in a predetermined description format, the printing managing program which manages print processing of the printed matter. The program comprises causing input of a printing instruction which describes each printing step of printing linkages steps which offers a printing related service; causing detection of a processing section which interprets the printing instruction described in a predetermined description format and processes the printing related service; causing detection of a description format which is to be interpreted; for each of the printing steps included in the inputted printing instruction, causing setting of a processing section for processing the printing step which offers the printing related service; and causing outputting a work instruction in which work items relating to the printing step are described in a description format which is interpretable at the set processing section.

A medium is needed in order to distribute the program for managing the print processing of the printed matter in the above-described print managing apparatus. Thus, in the present aspect, by storing, on a program storing medium, the printing managing program for managing the print processing of a printed matter, the program can be easily fetched, and distribution thereof is easy.

A twelfth aspect of the present invention is a printing system which carries out print processing of an image onto a recording medium in accordance with a printing instruction in which request items expressing requirements for preparation of a printed matter are described in a predetermined description format, the printing system comprises processing apparatuses provided in correspondence with printing steps offering printing related services which are classified in advance from a request to furnishing of the printed matter; and a print managing apparatus which manages print processing of the printed matter. The print managing apparatus includes an input section that inputs the printing instruction which describes each printing step of printing linkage steps which offers a printing related service; a detecting section that detects a processing section, which interprets the printing instruction described in a predetermined description format and processes the printing related service, which are provided for the respective printing steps described in the printing instruction and detects a description format which can be interpreted at the processing section; and an output section that sets the processing section for processing the printing step which offers the printing related service and outputs a work instruction in which work items relating to the printing step are described in a description format which can be interpreted at the set processing section.

This printing system can be structured by electrically connecting the processing sections and the print managing apparatus by using a local area network or the like. Thus, in the present embodiment, the printing system is structured from processing apparatuses which are provided in correspondence with printing steps offering printing related services which are classified in advance from a request to furnishing of the printed matter; and a print managing apparatus managing print processing of the printed matter. In this way, it is possible to provide a printing system in which the print processing of the printed matter can be easily executed even if there are both printing instructions in the predetermined description format and printing instructions in a description format different from the predetermined description format, and the processing sections can each interpret only one of these description formats.

Hereinafter, embodiments of the present invention will be described in detail with reference to the drawings.

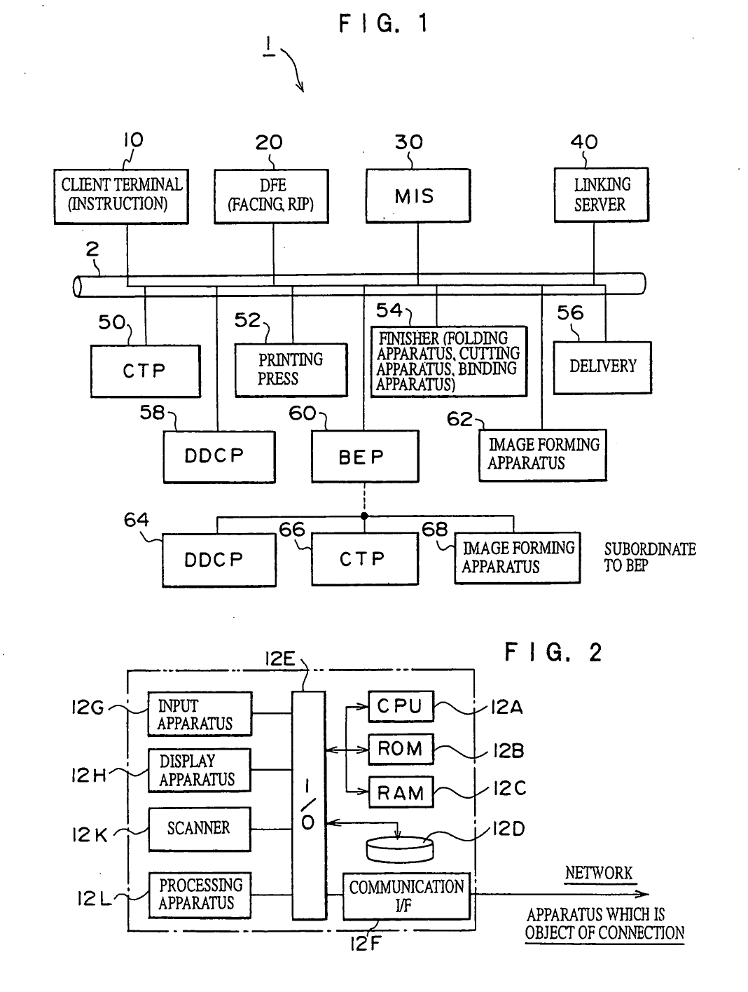

FIG. 1 is a block diagram showing the structure of a print processing system 1 relating to an embodiment of the present invention.

In the print processing system 1, apparatuses for realizing various services relating to print processing are connected via a network 2. Here, “service” means a function relating to printing which can be utilized in accordance with an external request. Processings such as, for example, preparation of layout data, facing, data conversion, preparation of a printing plate, printing, folding, cutting, binding, and the like correspond to services, but services are not limited to these processings.

In further detail, the print processing system 1 includes a client terminal 10 which has a user interface and which instructs print processing for ultimately obtaining, by a plurality of services, a printed matter desired by the user, a DFE (Digital Front End Processor) apparatus 20, an MIS (Management Information System) apparatus 30, a linking server 40, a CTP (Computer To Plate) apparatus 50, a printing press 52, a finisher apparatus 54, and a delivery managing apparatus 56.

The DFE apparatus 20 is an apparatus which transfers printing data to an image forming apparatus such as a CTP or a printer or the like, and instructs printing. The MIS apparatus 30 is an apparatus which controls the apparatuses which are in charge of execution of processings of services in accordance with a printing instruction (first printing instruction) in which information relating to the service procedures instructed by the client terminal 10 is described in a predetermined description format (e.g., JDF: Job Definition Format). The linking server 40 is an apparatus which controls nodes such as programs or apparatuses or the like which are in charge of the execution of processings of services in accordance with a printing instruction (second printing instruction) in which information relating to service linkage instructed at the client terminal 10 is described in another description format. The printing instructions described in these description formats can be expressed in a predetermined language (e.g., XML: Extensible Markup Language). Namely, a printing instruction can be prepared by being expressed in XML in accordance with a predetermined description format or another description format. Note that the language is not limited to XML.

The CTP apparatus 50 is an apparatus which directly forms a printing plate from printing data, without forming an intermediate product. The printing press 52 is an apparatus which prints by using the printing plate formed from the printing data. The finisher apparatus 54 is an apparatus which obtains the printed matter desired by the user (e.g., after binding), by folding, cutting, and binding the sheets after printing. The delivery managing apparatus 56 is an apparatus which manages the processing of delivering the printed matter into the hands of the user.

The MIS apparatus 30 is an apparatus which controls the apparatuses which are in charge of the execution of processings of services in accordance with a printing instruction which is described in a predetermined format (e.g., JDF: Job Definition Format). In the present embodiment, the MIS apparatus 30 has a managing function of managing the entire print processing system 1. Therefore, the MIS apparatus 30 has the function of being able to prepare printing instructions described by specifications other than (e.g., in a description format other than) the predetermined description format such as JDF or the like.

A DDCP (Digital Direct Color Proofing) apparatus 58, a BEP (Back End Processor) apparatus 60, and an image forming apparatus 62 are connected to the network 2. The image forming apparatus 62 is an apparatus such as, for example, a color copier, a fax machine, a printer, or the like, which has a so-called printing function of forming an image on a recording medium by an electrophotographic system. The image forming apparatus 62 can have an apparatus structure which includes the functions of the aforementioned finisher apparatus 54. The DDCP apparatus 58 may be an output apparatus which carries out printing output for color proofing directly from DTP data, or may be an output apparatus which outputs a large plate which has been subjected to facing processing for plate forming. The BEP apparatus 60 is an apparatus which has the function of carrying out various types of processings on the data obtained after the printing data in accordance with the instruction from the client has been converted (RIP processed) into raster data. The BEP apparatus 60 can be connected to output apparatuses such as a DDCP apparatus 64 which is similar to the aforementioned DDCP apparatus 58, a CTP apparatus 66 which is similar to the aforementioned CTP apparatus 50, an image forming apparatus 68 which is similar to the aforementioned image forming apparatus 62, and the like. Namely, under the management of the BEP apparatus 60, any one of or plural of the DDCP apparatus 64, the CTP apparatus 66, and the image forming apparatus 68 can be connected.

The linking server 40 can have, as the system structure for realizing service linking, a service retrieving server which retrieves the desired service of the user, an instruction preparing server which prepares a printing instruction from information relating to the service linking instructed at the client terminal 10, and a linked processing server carrying out linked processings of respective services in accordance with the printing instruction. Moreover, the linking server 40 may have an image processing apparatus which carries out image processings such as noise removal processing of an image document, image rotating processing, OCR processing, binding of an image, or the like; a document managing server which manages documents; a document distributing server which distributes documents; and a service processing apparatus which carries out a service processing determined in advance.

“Service linking” means having relationships among services, such as the results of an arbitrary service determining the services to be started thereafter or affecting the operations of services from then on, or the like. Here, a “service” is a function relating to print processing which can be utilized in accordance with a request from the exterior. For example, copying, printing, scanning, fax transmission and receipt, mail distribution, storage to a repository and reading-out from a repository, OCR (Optical Character Recognition) processing, noise removal processing, and the like correspond to services, and the services are not particularly limited. Accordingly, the linking server 40 links plural services and manages the instruction of the print processing desired by the user. The linking server 40 makes the linked processings of the respective services be executed in accordance with the printing instruction, from information relating to service linking in accordance with the printing instruction.

In the present embodiment, the print processing system 1 is structured such that the plural apparatuses which carry out the predetermined printing related processings are connected via the network 2. The print processing system 1 is not particularly limited provided that the plural services are connected via the network 2.

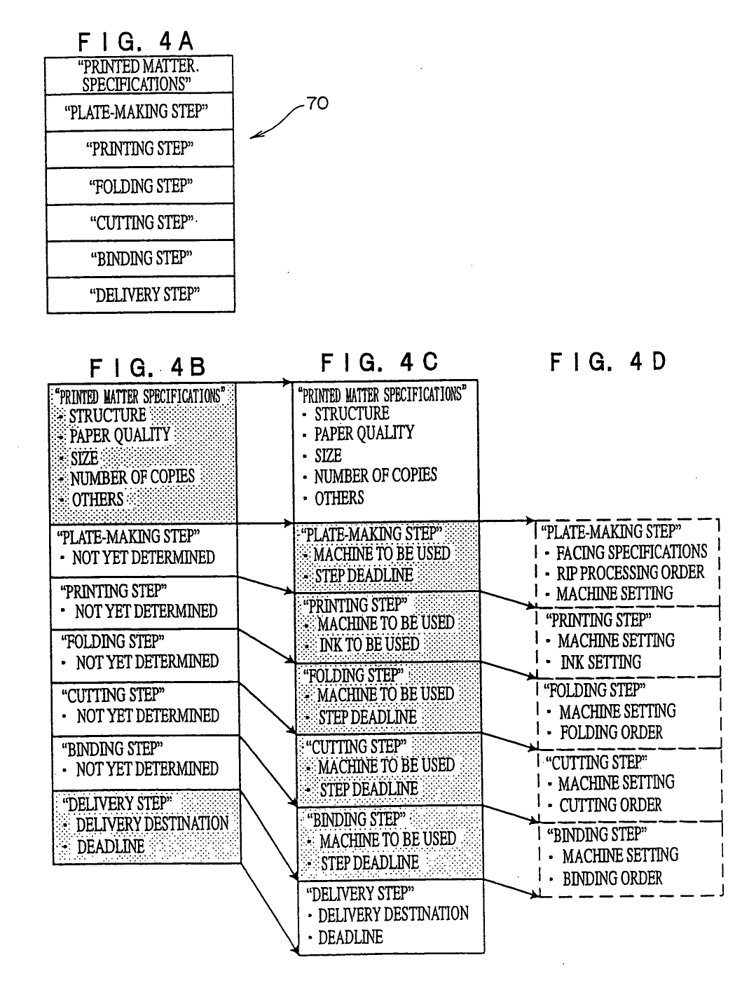

Here, the “printing instruction” is data which, when a series of processings relating to printing is dismantled into plural mechanical steps, includes information expressing the relationships of the respective steps, and parameter information utilized in functions executed in the respective steps. The printing instruction is described in a description format which is determined in advance (e.g., JDF or the like) (refer to FIGS. 4A through 4D).

FIG. 2 comprehensively shows the client terminal 10 as an example of the basic structure of each apparatus structuring the print processing system 1. At least a CPU 12A is provided, and is connected to an input/output bus (“I/O” in the figure) 12E. A ROM 12B and a RAM 12C are provided as elements associated with the CPU 12A. An input apparatus 12G such as a keyboard or a mouse or the like, a display apparatus 12H such as a display or the like, and a scanner apparatus 12K for image reading can be connected to the input/output bus 12E. Further, a processing apparatus 12L, such as a printer or a proofer or the like which realizes the functions of the processing at that apparatus, and a communication interface 12F, which is for connection with the network 2 or an apparatus which is an object of connection (a local host), can be connected to the input/output bus 12E.

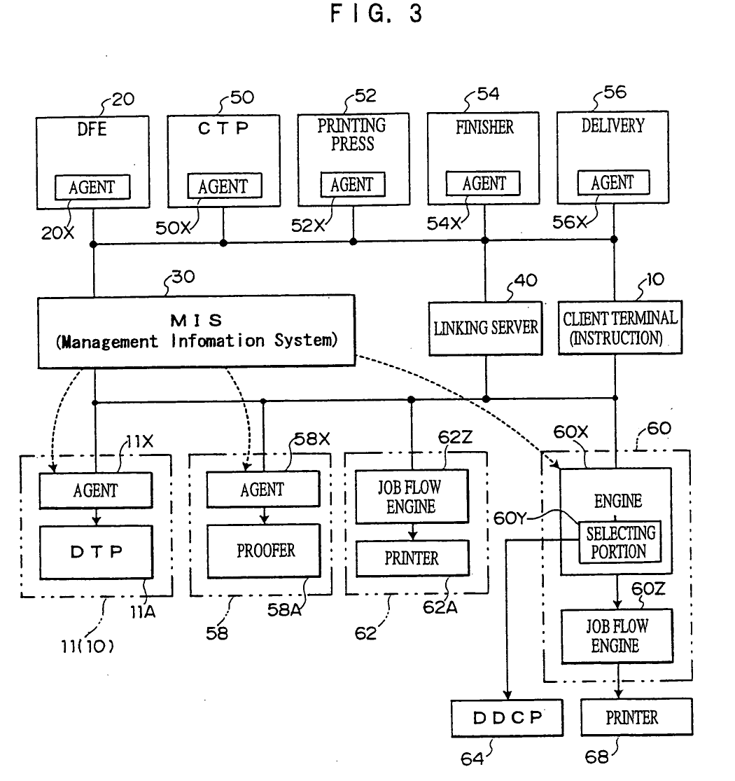

The respective apparatuses structuring the print processing system 1 operate by the hardware resources having these structures and by software resources which are processing programs stored in the ROM 12B and the RAM 12C. Note that each apparatus structuring the print processing system 1 has an agent function portion (see FIG. 3) which uses the hardware resources and the software resources and which is for interpreting the printing instruction. The agent function portion interprets the description format (e.g., JDF or the like) of the XML described in the printing instruction, and carries out conversion processing of the description format (e.g., JDF or the like) and the exclusive language used for operating the processing portion or the function portion which is the device of each apparatus structuring the print processing system 1.

FIG. 3 is a block diagram for explanation of the interrelationships among the respective apparatuses structuring the print processing system 1. Each apparatus has an agent function portion which stores interface information expressing the contents of the service which that apparatus provides, and which interprets the description contents described in the printing instruction. Note that, in the following explanation, unless otherwise stated, the agent function portion is structured so as to be able to interpret description contents which are described in a printing instruction which is described in a first description format (e.g., JDF).

Namely, each apparatus in FIG. 3 clearly shows the agent function portion, with the respective apparatuses shown in FIG. 1 being the basic structure. The client terminal 10 can selectively utilize printing instructions described in the first description format (e.g., JDF) and a second description format (e.g., an XML description format in accordance with a description format other than JDF). A DTP apparatus 11 enables processings based on printing instructions described in the first description format (e.g., JDF), and has an input editing function, and forms a photographic printing paper or a plate-making film or the like by using printing data obtained by processing a page layout on a computer. Therefore, the DTP apparatus 11 is structured from an agent function portion 11X and a DTP function portion 11A. Note that the DTP apparatus 11 may be structured so as to only have the functions of receiving printing data in accordance with a page layout prepared by the client terminal 10 and forming the photographic printing paper or the plate-making film or the like.

The respective apparatuses of FIG. 3 are the DFE apparatus 20, the CTP apparatus 50, the printing press 52, the finisher apparatus 54, the distribution managing apparatus 56, and the DDCP apparatus 58 as structures which can carry out processings based on printing instructions described in the first description format (JDF). The MIS apparatus 30 is an apparatus which exercises general control of management of printing instructions described in JDF. The linking server 40 is for exercising general control of management of printing instructions described in the second description format (e.g., an XML description format in accordance with a description format other than JDF).

In FIG. 3, there are differences in the structures of the image forming apparatus 62 and the image forming apparatus 68. Namely, the image forming apparatus 62 is a structure which is directly connected to the network 2, whereas the image forming apparatus 68 is subordinate to the BEP apparatus 60. In the present embodiment, the image forming apparatus 62 is for realizing the processings in accordance with printing instructions described in the second description format (e.g., an XML description format in accordance with a description format other than JDF). Therefore, the image forming apparatus 62 is structured from a job flow engine 62Z for interpreting printing instructions in the second description format, and a printer apparatus 62A. Namely, the job flow engine 62Z is a structure which interprets a printing instruction described in the second description format (e.g., an XML description format in accordance with a description format other than JDF), and converts the data into the language particular to the printer apparatus 62A. The job flow engine 62Z converts data, which is in accordance with an inputted printing instruction described in the second description format (e.g., an XML description format in accordance with a description format other than JDF), into data in the language particular to the printer apparatus 62A, and outputs this data to the printer apparatus 62A.

The BEP apparatus 60 is structured such that apparatuses subordinate thereto can implement both processings in accordance with printing instructions described in the first description format (e.g., JDF), and processings in accordance with printing instructions described in the second description format (e.g., an XML description format in accordance with a description format other than JDF). To this end, the BEP apparatus 60 has an agent function portion 60X for interpreting both description formats. Further, the BEP apparatus 60 can have the function of converting between the both description formats. The agent function portion 60X includes a selecting portion 60Y for selecting, as the connection destination thereof, an apparatus which can execute processings of a printing instruction in accordance with the first description format, and for selecting an output destination directed toward an apparatus which can execute processings of a printing instruction in accordance with the second description format. The DDCP apparatus 64 is connected to the selecting portion 60Y The image forming apparatus 68 is connected to the selecting portion 60Y via a job flow engine 60Z for interpreting printing instructions in accordance with the second description format.

FIGS. 4A through 4D are drawings showing the structure of the printing instruction and the flow of data addition. As shown in FIG. 4A, the printing instruction is structured such that the basic structure thereof is the fields of “Printed Matter Specifications”, “Plate Making Step”, “Printing Step”, “Folding Step”, “Cutting Step”, “Binding Step”, and “Delivery Step”. This printing instruction is described in a predetermined description format (e.g., JDF, or an XML description format in accordance with a description format other than JDF).

The “Printed Matter Specifications” are the respective items of the specifications of the printed matter which is the output result product of the print processing system 1. Items defined in advance are used as the “Printed Matter Specifications”, and are mainly inputted and set by a department such as business operations or the like which understands the needs of users such as the customers who request printed matter, and the like. For example, the structure, paper quality, size, number of copies, and the like correspond thereto. The “Plate Making Step” are items stipulating the process for making the plate for printing. The “Plate Making Step” is mainly inputted and set by a department such as step management or the like which manages the plate making step. For example, the machine which is used for plate making, the deadline by which the step must be completed, and the like correspond thereto. The “Printing Step” is items substantially stipulating the processing step of printing. The “Printing Step” is mainly inputted and set by a department such as step management or the like which manages the printing step. For example, the machine used for printing, the ink used for printing, and the like correspond thereto.

The “Folding Step” is items stipulating the processing step of folding the outputted matter after printing. The “Folding Step” is mainly inputted and set by a department such as step management or the like which manages the folding step. For example, the machine used for folding, the deadline by which the step must be completed, and the like correspond thereto. The “Cutting Step” is items stipulating the cutting processing step of cutting the outputted matter after printing or the outputted matter after completion of the folding processing. The “Cutting Step” is mainly inputted and set by a department such as step management or the like which manages the cutting step. For example, the machine used for cutting, the deadline by which the step must be completed, and the like correspond thereto. The “Binding Step” is items stipulating the processing step of binding the outputted matter after printing, or the outputted matter after completion of the folding processing, or the outputted matter after cutting. The “Binding Step” is mainly inputted and set by a department such as step management or the like which manages the binding step. For example, the machine used for binding, the deadline by which the step must be completed, and the like correspond thereto.

Due to a printing instruction 70, which is shown in FIG. 4A and in which the specific structure is not described, acquiring the wishes from the request for the printed matter, as shown in FIG. 4B, the “Printed Matter Specifications” and the “Delivery Step” are determined, and these determined items are described in the printing instruction 70. This processing is mainly implemented by input operation of the client terminal 10. Here, because specific items of the printing steps in accordance with the printing instruction 70 are not determined, the printing instruction 70 is distributed to the respective steps. As shown in FIG. 4C, data of the respective fields of “Plate Making Step”, “Printing Step”, “Folding Step”, “Cutting Step” and “Binding Step” are determined, and these determined items are described in the printing instruction 70. These processings are carried out by the apparatuses of the respective steps, and are basically not affected by other apparatuses (steps). Namely, it suffices for the determined items of each step shown in FIG. 4C, which are determined at the respective steps, to correspond to the specification items which are processed at that step with respect to the steps other than that step, and detailed data within the step is not needed. However, when actually carrying out processing at each step, a determination of detailed specifications is needed. Therefore, as shown in FIG. 4D, at each step, detailed specification items for the time of carrying out processing in that step are determined and are implemented.

The user reads out the printing instruction, and implements the linked processings until the printed matter is obtained. Specifics are as follows.

Note that, in the present embodiment, the control apparatus which is in charge differs depending on the description format of the printing instruction. As an example, a case will be described in which the MIS apparatus 30 is in charge of printing instructions of a description format in accordance with JDF (hereinafter, “JDF format”) as the first description format of printing instructions, and the linking server 40 is in charge of printing instructions of an XML description format in accordance with a description format other than JDF (hereinafter, “the other description format”) as the second description format of printing instructions. However, the MIS apparatus 30 has the managing function of managing the entire print processing system 1, and has the function of being able to prepare printing instructions described in description formats other than description formats such as JDF and the like (e.g., another format which is an XML description format in accordance with a description format other than JDF).

The client terminal 10 has a graphical user interface (GUI) function for carrying out predetermined operations such as instructing preparation of a printing instruction, and screen display for selecting the printing instruction to be started.

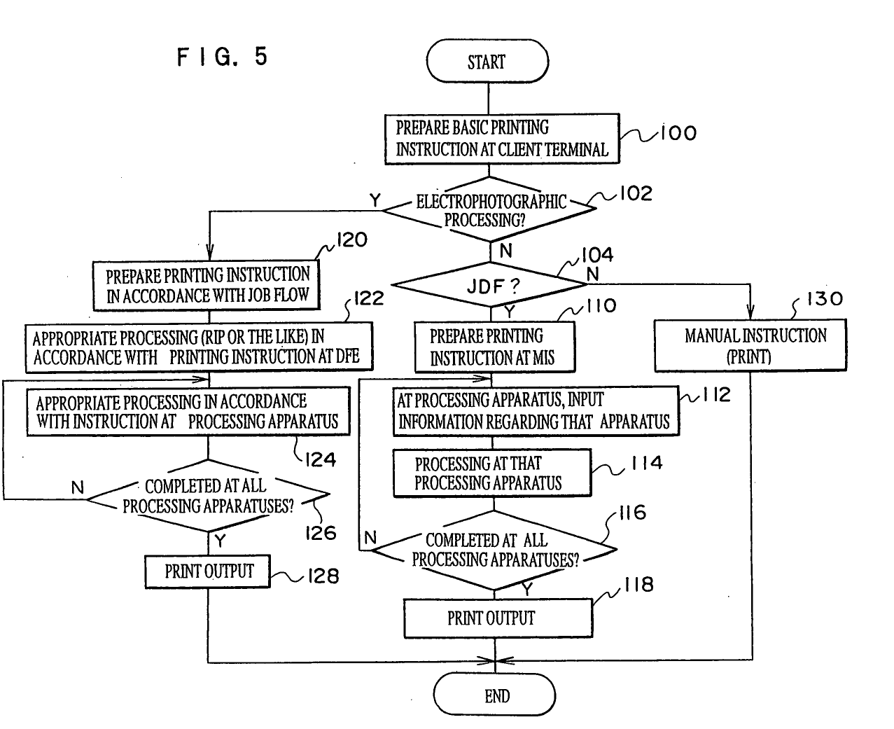

A process flowchart relating to linked processings from the request for printed matter to the obtaining of the printed matter is shown in FIG. 5.

First, at the client terminal 10, a printing instruction (see FIG. 4A) formed from respective fields which have not yet been filled-in has been stored in advance, and this basic printing instruction which is stored is read out (step 100). At the client terminal 10, the read-out basic printing instruction 70 is displayed. Due to the user filling in the initially needed items in the basic printing instruction by an input operation, the basic printing instruction 70 which expresses the requirements of the printed matter is prepared, and is outputted to the exterior.

In this case, one of a printing instruction of the description format of the printing instruction 70 (i.e., the other description format), a printing instruction in JDF format, and a printing instruction for manual instruction, is selectively instructed. At this time, any of the aforementioned printing instructions may be set as initial values, in order to obviate selection of the printing instruction by the user who is operating the client terminal 10.

Note that the printing instruction is not limited to being stored in the client terminal 10. For example, the printing instruction may be stored in advance in the MIS apparatus 30, and may be read-out from the MIS apparatus 30. Further, an accumulating server which accumulates printing instructions may be connected to the network 2, and a printing instruction may be read-out from the accumulating server. Moreover, the function of an accumulating server may be provided at another apparatus connected to the network 2, and the printing instruction may be outputted in accordance with a request. Still further, a plurality of printing instructions may be dispersed and used in common at other apparatuses connected to the network 2, and the printing service relating to the printing which the user desires may be retrieved from among the plural apparatuses connected to the network 2.

Next, because one of a printing instruction in another description format, a printing instruction in JDF format, and a printing instruction for manual instruction is selected and instructed as the printing instruction 70, the processes up to the obtaining of the printed matter corresponding to the requirements of the printed matter are different. Namely, differentiation between the aforementioned three types of printing instructions is carried out (steps 102, 104). In the case of a printing instruction of another description format (an affirmative judgment in step 102), the printing instruction is prepared at the linking server 40 (step 120). In the case of a printing instruction in JDF format (a negative judgment in step 102 and an affirmative judgment in step 104), the printing instruction is prepared at the MIS apparatus 30 (step 110). In the case of a printing instruction for manual instruction (negative judgments in steps 102 and 104), the printing instruction is printed (step 130).

Note that the determination of the format of the printing instruction in step 102 may be carried out at the MIS apparatus 30 and the linking server 40 respectively, or may be carried out by providing, within the print processing system 1, a processing apparatus having a determining function.

In the print processing system 1 of the present embodiment, the processing apparatus which processes the printing service executes processes as follows, in accordance with the format of the printing instruction.

First, the processes corresponding to a printing instruction in JDF format will be described. When the basic printing instruction is a printing instruction in JDF format, the printing instruction is prepared at the MIS apparatus 30 (step 110).

Note that not all of the information relating to control of the linked processings of the services related to printing are described in the printing instruction in JDF format. In the printing instruction in JDF format, basic fields which are the steps relating to printing (hereinafter “printing related steps”) are described, and the items in the fields are successively supplemented by the apparatuses which implement the respective services. In order to realize this linked processing, the MIS apparatus 30 can generate a basic printing instruction (see FIG. 4A) for linking (the services executed in) the printing related steps. Namely, the MIS apparatus 30 obtains and retrieves in advance location information expressing the positions (of the nodes) on the network 2 of the apparatuses which are in charge of or manage the printing related steps (services) in advance, and knows and manages the processing apparatuses which are dispersed on the network 2 and which process the printing related steps. Then, for the aforementioned basic printing instruction, the MIS apparatus 30 prepares an HTML file which becomes a GUI screen for reflecting the requests of the user, and in accordance with a request from the client terminal 10, transmits to the client terminal 10 the basic printing instruction as an HTML file which becomes a GUI screen.

The client terminal 10 transmits to the MIS apparatus 30 the HTML file which includes in-field items defined by operation of the user. The MIS apparatus 30 receives this HTML file, and prepares a printing instruction in which at least the requests of the user are reflected (FIG. 4B). The printing instruction is structured as a file in JDF format.

The MIS apparatus 30 can manage the interpretation and execution of the printing instruction, and the apparatuses relating thereto. The MIS apparatus 30 interprets the basic printing instruction received (from the client terminal 10), and in accordance with the printing related steps described in the printing instruction, outputs instructions to the respective processing apparatuses, and executes the printing linked processings. The MIS apparatus 30 stores information of the statuses of the linked processings which are currently being executed or information of the results of the linked processings which have been completed, and can give notice of the statuses or the results of the linked processings in accordance with a request from the exterior.

When the MIS apparatus 30 interprets the printing instruction and sends requests to the processing apparatuses in charge of the respective printing linked processes, there is no need to generate individual instruction information which have processing request contents, input parameters, information for specifying the document which is the object of processing, or the like, and these are processed within the printing related steps. Namely, the request of the MIS 30 to the processing apparatus is, provided that there is no particular instruction from the user, merely a notice that there is a request for the printing related step. Further, the processing apparatuses which are in charge of the respective printing related steps notify the MIS apparatus 30 of information relating to the specifications needed up to the time that the printed matter is obtained, such as the machines which can be used, the deadlines, and the like with respect to the request. On the basis thereof, the MIS apparatus 30 can supplement the fields of the printing instruction 70.

The specific processes are as follows.

In the start-up processing, the processing apparatuses which are in charge of the printing related steps notify the MIS apparatus 30 of interface information including information expressing summaries of the respective printing related steps and the addresses. Further, the processing apparatuses in charge of the printing related steps set various types of specifications for managing the details of the respective printing related steps. The MIS apparatus 30 stores the interface information transmitted from the respective processing apparatuses in charge of the printing related steps.

In accordance with operation of the user and through an installed browser, the client terminal 10 accesses the URL (Uniform Resource Locator) of the HTML file or the like which has been prepared for a user interface screen, which URL the client terminal 10 itself internally provides or another service provides. In accordance with this browse request, the HTML file (basic printing instruction) of the user interface screen is sent to the client terminal 10 from the access destination, and is displayed on the screen at the client terminal 10. At this time, by using the user interface screen displayed on the client terminal 10, the user can define the specifications for obtaining the desired printed matter. Namely, the user inputs items such as the specifications and the like of the requested printed matter.

When the specifications of the printed matter have been defined via the user interface screen, the client terminal 10 transmits to the MIS apparatus 30 a printing instruction which includes the specifications of the printed matter defined by the user (an HTML file including infield items defined by operation of the user).

On the basis of the printing instruction (the HTML file) which includes the specifications of the printed matter and is transmitted from the client terminal 10, and on the basis of the interface information acquired from the respective processing apparatuses, the MIS apparatus 30 prepares a printing instruction which defines information for specifying the respective printing related steps (step 110). In this way, the MIS apparatus 30 obtains a printing instruction in JDF format.

Next, the MIS apparatus 30 starts execution of the linked processings corresponding to the printing instruction in accordance with the instruction of the client terminal 10 (steps 112 through 118). First, the MIS apparatus 30 interprets the printing instruction from the client terminal 10, and for one printing related step described therein, informs the processing apparatus, which is in charge of that printing related step, that there has been a request instruction for the printing related step. The processing apparatus, which receives this and which is in charge of that printing related step, causes input of information relating to the specifications needed up to the time that the printed matter is obtained, such as the apparatus which can be used and the deadline and the like in its own step, and informs the MIS apparatus 30 of them (step 112). In addition thereto, the processing apparatus generates specific, individual instruction information having the processing request contents, input parameters, information for specifying the document which is the object of processing, and the like. Then, the processing apparatus implements the processing of the requested printing related step (step 114). The MIS apparatus 30 repeats the above-described processings until the instructions for all of the printing related steps described in the printing instruction have been completed (step 116). Processings of the DFE apparatus 20, the CTP apparatus 50, the printing press 52, the finisher apparatus 54, the delivery managing apparatus 56, the DDCP apparatus 58, and the like, correspond to the printing related steps here.

When all of the processings have been completed (an affirmative judgment in step 116), the processings in accordance with the printing instruction have been completed, and a corresponding post-processing is executed (step 118). Here, the printed matter prepared at the printing press 52 becomes a final printed matter at the finisher apparatus 54, and post-processing, such as managing the delivering at the delivery managing apparatus 56 or the like, is applicable.

Note that it is possible to carry out only the processings of inquiry and response relating to only the completion of the printing instruction (steps 112 through 116), and to carry out post-processing of the printed output (step 118) in accordance with a printing instruction prepared as a result thereof.

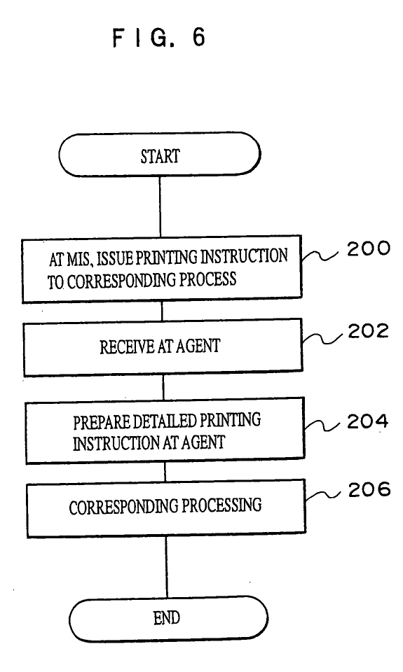

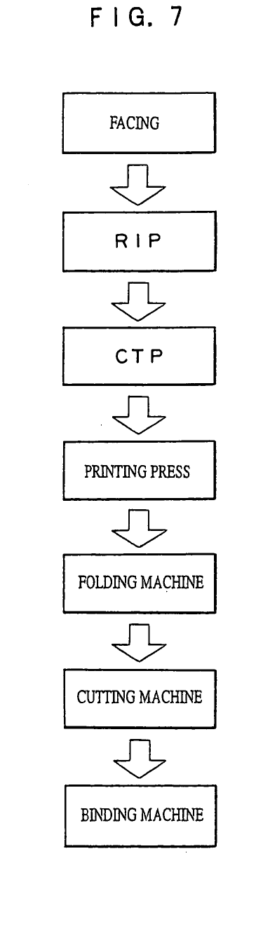

Details of processings, which are carried out at the processing apparatus which is in charge of one printing related step described in the printing instruction from the client terminal 10 interpreted at the MIS apparatus 30, i.e., the processings carried out at the processing apparatus in steps 112 and 114, will be described. A process flowchart relating to the processings carried out at the processing apparatus which is in charge of the one printing related step is shown in FIG. 6. Note that, hereinafter, description will be given of a case in which the “Printing Step” is used as an example of the printing related step and the printing press 52 is used as an example of the processing apparatus which is in charge of the printing related step.

First, the MIS apparatus 30 interprets the printing instruction, and for the “Printing Step” described therein, requests implementation of the corresponding service (print processing) (step 200). Here, a printing instruction in JDF format is issued to the printing press 52, and an agent 52X at the printing press 52 receives this printing instruction (step 202). The agent 52X interprets the received printing instruction which is in JDF format, and extracts the portion corresponding in its own process. The agent 52X displays, or the like, the instruction from the MIS apparatus 30, and displays a user interface screen in order to make the user who is managing the “Printing Step” input the information relating to the specifications needed up to the time that the printed matter is obtained, such as the apparatus which can be used and the deadline and the like in the “Printing Step”. In this way, the user who is managing the “Printing Step” inputs the needed items such as the specifications and the like of the “Printing Step”. The MIS apparatus 30 is informed of these inputted items. The state in which the items such as the specifications of the “Printing Step” and the like are inputted is shown in FIG. 4C.

Together therewith, the agent 52X generates specific, individual instruction information having the processing request contents, the input parameters, information for specifying the document which is the object of processing, and the like (step 204). In this way, the processings in the “Printing Step” can be executed. The individual printing instruction in which are inputted the items of the specific, individual instruction information in the “Printing Step” (the items of machine setting and ink setting in FIG. 4C), is shown in FIG. 4D. Then, as the corresponding processing in the “Printing Step”, the printing press is operated and printing is carried out in accordance with the individual printing instruction shown in FIG. 4D (step 206).

Next, the processes corresponding to a printing instruction in another description format will be described. First, when the basic printing instruction is a printing instruction in another description format in XML, the printing instruction is prepared at the linking server 40 (step 120).

Note that all of the information relating to control of the linked processing of the services related to printing are described in the printing instruction in the other description format. In order to realize this linked processing, the linking server 40 retrieves services relating to the print processing, and can generate a printing instruction for linking these services. Namely, the linking server 40 acquires in advance location information expressing the positions (of the nodes) on the network 2 which execute the services relating to the print processing in advance. On the basis of this location information and from the processing apparatuses executing the services related to the print processing which are dispersed on the network 2, the linking server 40 acquires and manages interface information expressing the input/output relationships of application programs and the respective processing apparatuses. On the basis of the acquired interface information, the linking server 40 prepares an HTML file which becomes a GUI screen for defining the job flow (the way of linking the services), and in accordance with a request from the client terminal 10, transmits to the client terminal 10 the HTML file which becomes the GUI screen.

The client terminal 10 transmits, to the linking server 40 and in accordance with CGI format, job flow information defined by operation of the user. On the basis of the job flow information relating to the service linkage instruction from the user and on the basis of the interface information of the respective services, the linking server 40 prepares a printing instruction which defines the contents of the processings requested to the respective services, input parameters, the way of linking the respective services (the job flow), and information for specifying the document which is the object of processing such as the document name, storage location information, or the like. The printing instruction is structured as a file in the other description format.

The linking server 40 can interpret and execute the printing instruction. The linking server 40 interprets the printing instruction received (from the client terminal 10), and, in accordance with the order and the method of use described in the printing instruction, calls-up in order the service processing apparatuses of the respective processing apparatuses (the image forming apparatus 62 and the like in the present embodiment), and executes the linked processings. Further, the linking server 40 stores information of the status of a linked processing which is being executed or the results of a linked processing which has been completed, and can give notice of the status or the results of the linked processing in accordance with a request from the exterior.

When the linking server 40 interprets the printing instruction and sends requests to the respective service processing apparatuses, the linking server 40 generates individual instruction information having the processing request contents, input parameters, information for specifying the document which is the object of processing, and the like. Note that the linking server 40 may describe, in the printing instruction, the relationships with the processings before and after the processings carried out at the respective service processing apparatuses, or may carry out the processing requests not in the format of the printing instruction, but rather in respective information exchange formats which are particular to the respective processing apparatuses and application programs executing the respective services.

The image forming apparatus 62, which is an example of the apparatus which implements the printing service, processes the document, i.e., carries out printing, on the basis of the service processing request contents, the input parameters, and the information regarding the document which is the object of processing, which are included in the processing request from the linking server 40. At the time of start-up, the image forming apparatus 62 informs the linking server 40 of its own interface information. This interface information is utilized at the time of preparing the printing instruction.

Specific processes are as follows.

In the start-up processing, the service processing apparatuses, such as the image forming apparatus 62 or the like, notify the linking server 40 of their interface information including information expressing the respective service summaries and addresses. The linking server 40 stores the interface information transmitted from the respective service processing apparatuses such as the image forming apparatus 62 and the like.

First, in accordance with the operation of the user and through the installed browser, the client terminal 10 accesses the URL (Uniform Resource Locator) of the HTML file which has been prepared for the user interface screen, which URL the client terminal 10 itself internally provides or another server provides. In accordance with a browse request, the HTML file of the user interface screen is sent from the access destination to the client terminal 10, and is displayed on the screen at the client terminal 10. At this time, by using the user interface screen displayed on the client terminal 10, the user can define the desired flow of print processing linkage (hereinafter called the “printing linking flow”).

When the printing linking flow has been defined via the user interface screen, the client terminal 10 transmits, to the linking server 40, the printing linking flow information relating to the printing linking defined by the user.

On the basis of the information relating to the printing linking flow transmitted from the client terminal 10 and on the basis of the interface information obtained from the respective processing apparatuses, the linking server 40 prepares a printing instruction which defines the contents of the processings requested to the respective services, the input parameters, the way of linking the respective services, and information for specifying the document which is the object of processing such as the document name, storage location information, or the like (step 120). Then, the linking server 40 obtains a printing instruction in another description format.

Next, the linking server 40 starts execution of the linked processings corresponding to the printing instruction which is in accordance with the instruction of the client terminal 10 (steps 122 through 128).

The linking server 40 interprets the printing instruction, and, for the initial processing described therein, requests execution of the appropriate service processing (step 122). Here, RIP processing which generates an image for printing is appropriate. The linking server 40 prepares the individual instruction information for the DFE apparatus 20, and transmits it. At the DFE apparatus 20, the RIP processing generating the image is executed. When this processing is completed, the DFE apparatus 20 transmits, to the linking server 40, the results of processing such as processing status information (completed), output parameters, storage destination information of the document after processing (location information of the DFE apparatus 20 itself or of another apparatus), and the like.

Next, the linking server 40 interprets the printing instruction, and for the next processing described therein, requests execution of the appropriate service processing (step 124). Here, print processing which prepares a print at the image forming apparatus 62 is appropriate. The linking server 40 prepares the individual instruction information for the image forming apparatus 62, and transmits it. At the image forming apparatus 62, print processing is carried out. When this processing is completed, the image forming apparatus 62 transmits, to the linking server 40, the results of processing such as processing status information (completed), output parameters, storage destination information of the document after processing (location information of the image forming apparatus 62 itself or of another apparatus), and the like.

Next, the linking server 40 interprets the printing instruction, and judges whether or not there is another processing described therein. If there is a service which has not yet been processed (a negative judgment in step 126), the above-described processings are repeated. When all of the processings have been completed (an affirmative judgment in step 126), the processings in accordance with the printing instruction are completed, and the corresponding post-processing is carried out (step 128). Here, post-processings such as distributing the prints prepared at the image forming apparatus 62 or classifying the prints or the like, are appropriate.

Note that the linking server 40 can manage the processing results and the processing request results of the image forming apparatus 62 and the like as a log.

Next, the processes corresponding to a printing instruction in a manually instructed format will be described. Here, the printing instruction is a format which does not depend on the above-described formats, and there are cases in which the user executes the printing related processings by individual notification or notification in accordance with another communication form, or the like. Namely, the printing instruction in a manually instructed format is prepared at the client terminal 10 (step 130).

Note that all of the information relating to control of the linked processings of the services related to printing must be described in a printing instruction in a manually instructed format. In order to describe all of the information related to control of the linked processings of the services related to printing, the client terminal 10 has readied in advance a template into which all of the information can be filled-in. Due to the client terminal 10 filling-in (inputting information into) the template, the data of the printing instruction is prepared, and this is printed. By using the printed print, the user, by manual instruction, realizes the linked processings of the services related to printing by manual operation. Fusion of Automated Flow of Printing and Job Flow of Electrophotography.

As described above, in the print processing system 1 of the present embodiment, print processing using a conventional printing plate or print processing in accordance with an electrophotographic system can be executed on the basis of a first printing instruction in JDF or a second printing instruction in another description format (see FIG. 5). The MIS apparatus 30 controls the printing services in accordance with the first printing instruction in JDF, and the linking server 40 controls the printing services in accordance with the second printing instruction in another description format.

However, there are many cases in which the control by the MIS apparatus 30 and the control by the linking server 40 cannot be associated with one another. This is because the description formats of the printing instructions are different, and linking of the controls is difficult. Thus, in the present embodiment, in order to accomplish print processing without being constrained by the description formats of the printing instructions (i.e., in order to fuse the automated flow of printing and the job flow of electrophotography), a managing function for managing the print processing system 1 overall is provided at a processing apparatus which is determined in advance in the print processing system 1 (the MIS apparatus 30 in the present embodiment).

The managing function for managing the entire print processing system 1 includes: a function of sensing the operation states (the connected states, the work states, or the like) of the processing apparatuses in charge of the respective printing steps within the print processing system 1; a function of setting the processing apparatuses within the printing steps; a function of preparing and issuing printing instructions which are description formats which can be interpreted by the respective processing apparatuses; and a function of changing a processing apparatus in accordance with the operation state of the processing apparatus.

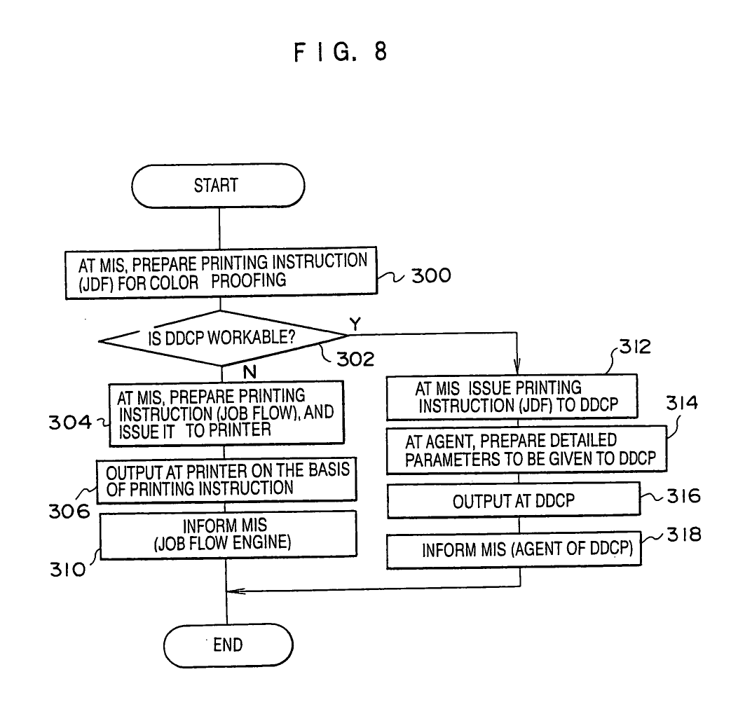

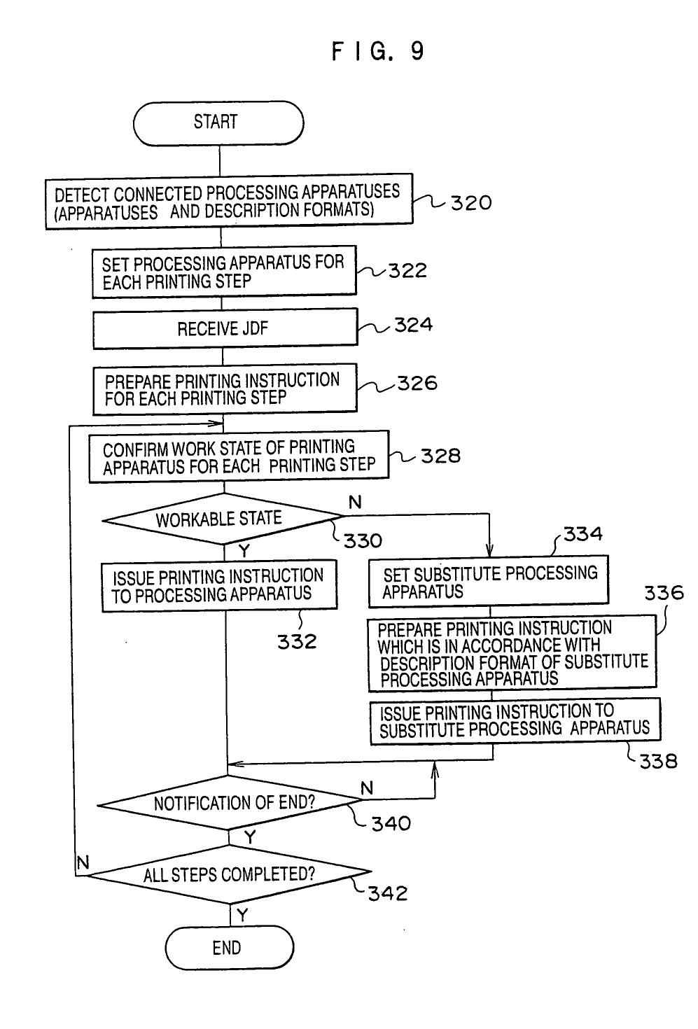

Hereinafter, description will be given, as an example of achieving the managing function, of a case in which processings, which are included in printing steps described by a first printing instruction (JDF), are accomplished on the basis of the operation states of the processing apparatuses belonging to the printing steps in the print processing system 1. Here, description will be given of a case in which, among the processings included in the printing steps instructed by the first printing instruction (JDF), those printing steps which are difficult to execute are replaced by processings at apparatuses at which processings based on second printing instructions are possible and which can execute processings which are the same as or processings determined in advance which are equivalent to those of the printing steps which are difficult to execute. As an example, explanation will be given, with reference to FIGS. 8 and 9, of a case in which, when printing for color proofing before printing is instructed by a first printing instruction, that processing is replaced by an apparatus at which processings based on second printing instructions are possible.

FIG. 8 shows the processes which are executed when an instruction for color proofing is included among printing related steps defined in a first printing instruction, and corresponds to the processings of steps 112 and 114 of FIG. 5. FIG. 9 shows the flow of processings and the MIS apparatus 30, and shows the processings, at the MIS apparatus 30, of steps 110 through 116 of FIG. 5. Further, in order to accomplish print processing without being constrained by the description format of the printing instruction, the MIS apparatus 30 has the function of carrying out both preparation of first printing instructions and preparation of second printing instructions, and also has the function of converting first printing instructions into second printing instructions.

First, at the MIS apparatus 30, a printing instruction is prepared (step 300) for the printing step of instruction of color proofing (actually, color proofing before printing), among the processings which are included in the printing steps instructed by the first printing instruction (JDF). Note that, when the printing instruction prepared by the above-described processing (step 100 in FIG. 5) can be used as is, this processing can be omitted. Next, the MIS apparatus 30 acquires the operation state of the DDCP 58 which is set as the processing apparatus of the printing step in charge of the color proofing, and judges whether or not the DDCP 58 is workable (can carry out the processing) (step 302). For example, a command can be transmitted to the DDCP 58 inquiring as to the state thereof, and the state of the DDCP 58 can be acquired by the absence/presence of a reply or the contents of the reply data. The operation state of the DDCP 58 may be a workable state in which the DDCP 58 is currently not executing a job and is in a standby state in which it can execute the processing, or a non-workable state such as the DDCP 58 is busy as it is in the midst of executing a job and cannot execute the processing, or it cannot execute the processing due to a malfunction, a disconnection, or the power being off.

When the state of the DDCP 58 is a non-workable state (a negative determination in step 302), the MIS apparatus 30 prepares a second printing instruction corresponding to the first printing instruction, i.e., a second printing instruction in which is described an instruction to carry out print processing for color proofing, and outputs the second printing instruction to the image forming apparatus 62 (step 304). This issued second printing instruction is received at the job flow engine 62Z of the image forming apparatus 62. The job flow engine 62Z interprets the received second printing instruction, describes in the second printing instruction the parameters which must be set at the printer 62A at the time of printing for color proofing, and outputs the second printing instruction to the printer 62A (step 306). Then, when the printer 62A receives the second printing instruction from the job flow engine 62Z, the printer 62A executes print processing for color proofing in accordance with the second printing instruction. The parameters described in the second printing instruction include various types of printing conditions such as, for example, a page sequence specifying the order of the pages to be printed, the type and the size of the paper to be printed on, and the like. These parameters, for example, may be stored as predetermined parameters in an internal memory and read-out and used, or parameters set by operation of the user may be used.

At this time, the job flow engine 62Z monitors whether or not the print processing by the printer 62A is completed. When the job flow engine 62Z senses that the print processing by the printer 62A has been completed, the job flow engine 62Z informs the MIS apparatus 30 of this fact (step 310). The MIS apparatus 30 thereby recognizes that the printing for color proofing has been completed, and issues a printing instruction to the apparatus which is to execute the next processing.

When the state of the DDCP 58 is the workable state (an affirmative judgment in step 302), the MIS apparatus 30 outputs the first printing instruction to the DDCP 58 (step 312). The first printing instruction issued from the MIS apparatus 30 is received at an agent 58X of the DDCP 58. The agent 58X interprets the received first printing instruction, describes in the first printing instruction the parameters which should be set at a proofer 58A at the time of the printing for color proofing, and outputs the first printing instruction to the proofer 58A (step 314). The parameters described in the first printing instruction include various types of printing conditions such as, for example, the angle, the type, the number of lines, and the profile of the screen. These parameters, for example, may be stored as predetermined parameters in an internal memory and read-out and used, or parameters set by operation of the user may be used.

When the proofer 58A receives the first printing instruction from the agent 58X, the proofer 58A executes the print processing for color proofing in accordance with the printing instruction (step 316). The agent 58X monitors whether or not the print processing by the proofer 58A is completed. When the agent 58X senses that the print processing by the proofer 58A has been completed, the agent 58X informs the MIS apparatus 30 of this fact (step 318). The MIS apparatus 30 thereby recognizes that the printing for color proofing has been completed, and issues a printing instruction to the apparatus which is to execute the next processing.

In order to accomplish the above-described processes, the processings in accordance with the flowchart shown in FIG. 9 are executed at the MIS apparatus 30. First, the MIS apparatus 30 detects the processing apparatuses connected to the print processing system 1 (step 320). The MIS apparatus 30 transmits commands inquiring as to the connected states, and, as replies thereto, obtains identification data expressing the processing apparatuses themselves, and obtains description format data expressing the description formats of printing instructions which can be interpreted at these processing apparatuses. The MIS apparatus 30 thereby detects the respective processing apparatuses. By storing these results of detection as a table, the processing apparatuses within the print processing system 1 can be registered. In this way, the MIS apparatus 30 can know of the processing apparatuses in charge of the printing steps in the print processing system 1. Note that, in cases such as when the processing apparatuses existing in the print processing system 1 are set or processing apparatuses are added or the like, if the processing apparatuses are known in advance, they can be registered in the aforementioned table by an input device such as a keyboard or the like.

When the MIS apparatus 30 learns of the processing apparatuses in the print processing system 1, the MIS apparatus 30 sets the processing apparatus corresponding to the printing step (step 322). When there are plural processing apparatuses in the printing step, this setting is the setting of any one processing apparatus or processing apparatuses of a number corresponding to the processings executed in the printing step. This set value is preferably recorded (registered) in the aforementioned table. In this setting, the priority order can be determined by the processing time of one job, the allowed processing amount, the past working time, the service life, and the like of the processing apparatus. Note that, when the processing apparatus has been set in advance for the printing step, it is possible to carry out the setting and the registration in the table by an input device such as a keyboard or the like in above step 320.

When the above-described processings have been completed, the MIS apparatus 30 stands-by for input of the printing instruction in order to carry out printing linked processing, and receives (step 324) the printing instruction outputted by the client terminal (step 100 in FIG. 5). Next, for the received printing instruction, the MIS apparatus 30 prepares printing instructions for the individual printing steps (work instructions) (step 326). Here, the printing instructions for the individual printing steps are first printing instructions (JDF).

When preparation of the printing instructions for the individual printing steps (i.e., the work instructions) is completed, the work states of the processings apparatuses of the respective printing steps are successively confirmed (step 328). This confirmation of the work states corresponds to the acquiring of the operation states of the respective processing apparatuses (step 302 in FIG. 8). Note that the processings from steps 328 on are carried out successively when the processings are linked in time sequence for each printing step described in the printing instruction. Further, when the printing steps can be carried out simultaneously and in parallel, they are processed in parallel.

When the processing apparatus of the printing step is in a workable state (an affirmative judgment in step 330), the printing instruction of above step 326 is issued to the processing apparatus (step 332). In this way, the processing apparatus of the printing step can execute the processing of the printing service which that apparatus offers.

When the processing apparatus of the printing step is in a non-workable state (a negative judgment in step 330), a substitute processing apparatus, which can execute the processing instead of the current processing apparatus which was set in step 322 and which is in charge of the processing step, is set (step 334). This setting is the setting of, among the processing apparatuses connected to the print processing system 1 and detected in step 320, a processing apparatus which can execute the processing instead of the processing apparatus which is in a non-workable state. At this time, the aforementioned table can be referred to if a priority order is set in the table. Note that, in this case, there is no need to consider the description format of printing instructions which the processing apparatus can interpret.

When the setting of the substitute processing apparatus is completed, the MIS apparatus 30 prepares a printing instruction in a description format which can be interpreted by that substitute processing apparatus (step 336), and issues the prepared printing instruction to the substitute processing apparatus (step 338). In this way, even when the processing apparatus of the printing step is in a non-workable state, it can be replaced by processing of a printing service offered by the substitute processing apparatus, and the printing step can be executed. Accordingly, the processings of the printings steps can be accomplished for each of the printing steps included in the printing instruction received in step 324.

The MIS apparatus 30 stands-by until it receives notice from the processing apparatus of the printing step that the processing has been completed (i.e., until the judgment in step 340 is affirmative). When the MIS apparatus 30 receives this notice, it judges whether the processings have been completed for all of the printing steps in the printing instruction (step 342), and repeats the above-described processings until the judgment becomes affirmative. In this way, the MIS apparatus 30 confirms that the printing steps have been completed, and can carry out management for executing the next processing.

In this way, in the present embodiment, when print processing is executed in accordance with the first printing instruction in JDF, in a case in which printing for color proofing is instructed, if the DDCP 58 at which processings based on printing instructions in JDF are possible is in a non-executable state, a second printing instruction in accordance with another description format and corresponding to the first printing instruction is generated (converted), and by outputting the second printing instruction to the image forming apparatus 62 at which processings based on second printing instructions are possible, the print processing for color proofing is executed. Therefore, even if the DDCP 58 is in a non-workable state due to a malfunction or for some other reason, it is possible to substitute therefor a print processing for color proofing by the image forming apparatus 62 which can carry out processing in accordance with an electrophotographic job flow. Accordingly, print processing can be carried out without, for example, missing the deadline or the like due to a mistake caused by the restoring of an apparatus malfunction, or the like.

The processing of receiving the printing instruction outputted by the client terminal (step 324) corresponds to the operation of the input section of the present invention. The processing of confirming the work state of the processing apparatus of the printing step (step 328) corresponds to the operation of the detecting section of the present invention. The processing, carried out by the MIS apparatus 30, of issuing a printing instruction to a processing apparatus when the processing apparatus of the printing step is workable (step 332), and the processing, carried out by the MIS apparatus 30, of issuing to a substitute processing apparatus a printing instruction in another format which can be interpreted at the substitute processing apparatus (step 338), correspond to the operations of the output section in the present invention. Further, an example of the processing section of the present invention is the above-described DDCP apparatus 58, the agent 58X corresponds to the agent portion, and the proofer 58A corresponds to the executing portion.

Note that, in the present embodiment, explanation is given of a case in which color proofing is used as an example of the printing step. However, the printing step is not limited to color proofing. Namely, the present invention is applicable provided that the processing apparatus which is in charge of the printing step included in the printing instruction can be substituted. For example, in a case in which a printed matter binding step is defined in the first printing instruction, if the finisher apparatus 54 which corresponds to JDF and has a binding function is in a non-workable state, a second printing instruction corresponding to the first printing instruction is prepared. By outputting this second printing instruction to the image forming apparatus 62 which has a binding function, the binding function can be substituted.

The present embodiment describes a case in which, if a processing cannot be executed at an apparatus at which processings based on first printing instructions are possible, a similar processing is carried out at an apparatus at which processings based on second printing instructions are possible. However, the present invention is not limited to preparing or converting into different printing instructions. Namely, a processing apparatus, which can interpret first printing instructions and which can execute the same processing as an apparatus for first printing instructions, can be used as the substitute processing apparatus.

When a substitute processing apparatus is set, there are cases in which the substitute processing apparatus is selected from among a plurality of exactly the same apparatuses, but the apparatuses may have the same function but are different models, or the manufacturers of the apparatuses may be different, or there may be differences in the description formats. In such cases, the differences which ultimately arise are in the processing time and the processing accuracy (the processing quality such as printing quality or the like). Therefore, setting of a substitute processing apparatus can be carried out actively. Namely, in the above description, the work state is detected and when it is found to be an workable state, the processing apparatus is switched. However, a structure is possible in which the work state is learned of, and, in a state in which the processing time and processing accuracy are set in advance or inputted, the processing apparatus is substituted by a processing apparatus which accords therewith. In this way, when a user requests extremely urgent printing, by accomplishing the print processing by setting the fastest processing apparatuses within the print processing system 1, printed matter can be provided in a state coinciding with the requests of the user.

Further, in the present embodiment, description is given of a case in which print processing for color proofing is carried out by the DDCP 58 or the image forming apparatus 62 which are directly connected to the network 2. However, the present invention can be applied even in a case in which color proofing processing is made to be carried out by the DDCP 64 or the image forming apparatus 68 which is connected subordinately to the BEP 60. In this case, the acquisition of the state of the DDCP 64 and the issuing of the first printing instruction or the second printing instruction to the processing apparatus may be carried out via the agent function portion 60X of the BEP 60. In this way, processing can be carried out in the same way as described above.

1. A print managing apparatus included in a printing system which carries out print processing of an image onto a recording medium in accordance with a printing instruction in which request items expressing requirements for preparation of a printed matter are described in a predetermined description format, the print managing apparatus managing print processing of the printed matter, the apparatus comprising:
an input section that inputs the printing instruction which describes each printing step of printing linkage steps which offers a printing related service;
a detecting section that detects a processing section, which interprets the printing instruction described in a predetermined description format and processes the printing related service, which are provided for the respective printing steps described in the printing instruction and detects a description format which can be interpreted at the processing section; and
an output section that sets the processing section for processing the printing step which offers the printing related service and outputs a work instruction in which work items relating to the printing step are described in a description format which can be interpreted at the set processing section.

2. The print managing apparatus of claim 1, wherein the printing system includes a plurality of the processing sections, and the plurality of the processing sections includes at least one of a processing section which interprets printing instructions in the predetermined description format and processing its own printing related service, and a processing section which interprets printing instructions in another description format different from the predetermined description format and processing its own printing related service.

3. The print managing apparatus of claim 1, wherein the detecting section detects an operation state of the processing section in charge of the printing step, and, when that processing section is detected to be non-operable, the output section sets a predetermined processing section which is to be in charge of that printing step.

4. The print managing apparatus of claim 3, wherein the detecting section is structured so as to detect the operation state of the processing section when print processing of the image onto the recording medium in accordance with the printing instruction is to be carried out.

5. The print managing apparatus of claim 1, wherein the printing steps are structured so as to include at least a proofing processing step.

6. The print managing apparatus of claim 2, wherein at least one of the processing sections includes an agent portion which interprets the work instruction and converts the interpreted work instruction into data particular to an apparatus and outputs the data particular to the apparatus, and an executing portion which processes the printing related service on the basis of the data particular to the apparatus.

7. The print managing apparatus of claim 6, wherein the agent portion is structured so as to convert the work instruction into data particular to the apparatus, which data corresponds to the work instruction and is in accordance with predetermined parameters particular to the executing portion.

8. The print managing apparatus of claim 1, wherein the printing instruction in the description format different from the predetermined description format, or the work instruction which describes work items and which can be interpreted at the processing section, includes details of processings to be implemented in the printing step.

9. A printing managing method executable in a printing system which carries out print processing of an image onto a recording medium in accordance with a printing instruction in which request items expressing requirements for preparation of a printed matter are described in a predetermined description format, the printing managing method managing print processing of the printed matter, and the method comprising:
inputting a printing instruction which describes each printing step of printing linkage steps which offers a printing related service;
detecting a processing section, which interprets the printing instruction described in a predetermined description format and processes the printing related service;
detecting a description format which is interpretable at the processing section; and
for each of the printing steps included in the inputted printing instruction, setting the processing section for processing the printing step which offers the printing related service and outputs a work instruction in which work items relating to the printing step are described in a description format which is interpretable at the set processing section.

10. A printing managing program executable by a computer provided at a printing system which carries out print processing of an image onto a recording medium in accordance with a printing instruction in which request items expressing requirements for preparation of a printed matter are described in a predetermined description format, the printing managing program which manages print processing of the printed matter, the program comprising:
causing input of a printing instruction which describes each printing step of printing linkages steps which offers a printing related service;
causing detection of a processing section which interprets the printing instruction described in a predetermined description format and processes the printing related service;
causing detection of a description format which is to be interpreted;
for each of the printing steps included in the inputted printing instruction, causing setting of a processing section for processing the printing step which offers the printing related service; and
causing outputting a work instruction in which work items relating to the printing step are described in a description format which is interpretable at the set processing section.

11. A storage medium storing a printing managing program executable by an apparatus provided at a printing system which carries out print processing of an image onto a recording medium in accordance with a printing instruction in which request items expressing requirements for preparation of a printed matter are described in a predetermined description format, the printing managing program which manages print processing of the printed matter, and the program comprising:
causing input of a printing instruction which describes each printing step of printing linkages steps which offers a printing related service;
causing detection of a processing section which interprets the printing instruction described in a predetermined description format and processes the printing related service;
causing detection of a description format which is to be interpreted;
for each of the printing steps included in the inputted printing instruction, causing setting of a processing section for processing the printing step which offers the printing related service; and
causing outputting a work instruction in which work items relating to the printing step are described in a description format which is interpretable at the set processing section.

12. A printing system which carries out print processing of an image onto a recording medium in accordance with a printing instruction in which request items expressing requirements for preparation of a printed matter are described in a predetermined description format, the printing system comprising:
processing apparatuses provided in correspondence with printing steps offering printing related services which are classified in advance from a request to furnishing of the printed matter; and
a print managing apparatus which manages print processing of the printed matter, the print managing apparatus including:
an input section that inputs the printing instruction which describes each printing step of printing linkage steps which offers a printing related service;
a detecting section that detects a processing section, which interprets the printing instruction described in a predetermined description format and processes the printing related service, which are provided for the respective printing steps described in the printing instruction and detects a description format which can be interpreted at the processing section; and
an output section that sets the processing section for processing the printing step which offers the printing related service and outputs a work instruction in which work items relating to the printing step are described in a description format which can be interpreted at the set processing section.
